(19) United States
(12) Patent Application Publication
(10) Pub. No.: US 2011/0036443 A1
(43) Pub. Date: Feb. 17, 2011

(54) Nano FIR and anion fuel pipes for motor vehicle and the like

(76) Inventor: Yixin Guo, Ronkonkoma, NY (US)

Correspondence Address: Yixin Guo, 256 Holbrook Ave., Ronkonkoma, NY, 11779, US

(21) Appl. No.: 12/583,052

(22) Filed: Aug. 13, 2009

(51) Int. Cl. F16L 9/14

(52) U.S. Cl. 138/140

(57) ABSTRACT

A rubber or plastic fuel pipe, which can be used for motor vehicles and ships, comprises a nano or sub-nano Far Infrared Ray (FIR) and anion carrier. The structures of the carrier are made up of nano or sub-nano tourmaline powders instead of non-nanoized tourmaline granules. The carrier can the whole body, interior wall, or exterior wall of the pipe. The carrier can also be paste set on the inner or outer wall surface of the pipe. The nano or sub-nano FIR anion carrier can facilitate sufficient combustion by breaking fuel molecular group into pieces. This carrier can achieve a far infrared emission rate up to 96% from ˜85% by non-nanoized tourmaline materials. As a result, the novel pipe can save extra maximum 12% fuels. The percentage of toxic gas in the exhaust will be correspondingly reduced.

### FIELD OF THE INVENTION

This invention describes a fuel pipe with different embodiments that can be applied in vehicles and ships' gasoline or diesel engine. It is a distinct fuel pipe with nano or sub-nano FIR and anion carrier structures. The fuel pipe can make fuel burn efficiently, and it can also reduce the emission of toxic exhaust such as carbon dioxide.

### BACKGROUND OF THE INVENTION

As the demand for petroleum soars, to fix the issues of both high cost of petroleum and the exhausted emissions from the devices consuming petroleum become challenges for the society. There are two different types of fuel economizers in the market, that is, economizers with either outer circle model or joint model. The principle of a fuel economizer is: when fuel is flowing to the fuel economizers, fuel economizer magnetizes fuel molecules. The fact that Carbon and Oxygen have opposite magnetic polarity induces that both Carbon and Oxygen are easily fused together producing a better and efficient combustion. As a result of the fusion of fuel and air, the engine works more efficiently generating greater power, reducing the consumption of fuel, and also the hydrocarbons (HC), carbon monoxide (CO) and nitrogen oxide which emanate from the exhaust.

The limitations of these two models of fuel economizers include: 1. Two models of fuel economizers can be installed only after customers bought the vehicles or ships, which is very inconvenient for both customers and manufacturers. 2. For the outer circle model and the joint model fuel economizers, there are technical problems with the installation. For example, for the joint model, in order to install the fuel economizer, the transmitting pipeline is needed to be severed. For this matter, it is very important to design a more effective fuel economizer to achieve the target of fuel saving.

### BRIEF SUMMARY OF THE INVENTION

The invention presents a nano or sub-nano fuel pipe effective for fuel saving and beneficial for environmental protection. The embodiments of the invention are: a FIR anion fuel pipe for vehicles and ships. The said fuel pipe comprises a carrier. The structures of the carrier, also named as FIR and anion carrier structures, are made up of tourmaline or tourmaline and germanium nano or sub-nano ore granule materials. Preferred embodiments of the present invention are described in more detail below with reference to the accompanying drawings. A plastic or rubber pipe with a carrier, where the structures of the carrier are described as follows:
1. The structures of nano FIR and anion carrier of a rubber or plastic pipe are made up of nano granules, and the carrier is the whole body of the pipe.
2. The structures of sub-nano FIR and anion carrier of a rubber or plastic pipe are made up of sub-nano granules, and the carrier is the whole body of the pipe.
3. The structures of nano FIR and anion carrier of a rubber or plastic pipe are made up of nano granules, and the carrier is the exterior or interior wall of the pipe body.
4. The structures of sub-nano FIR and anion carrier of a rubber or plastic pipe are made up of sub-nano granules, and the carrier is the exterior or interior wall of the pipe body.
5. The structures of the nano FIR and anion carrier are in the form of paste pasted to the inner or outer wall surface of the pipe body.
6. The structures of the sub-nano FIR and anion carrier are in the form of paste pasted to the inner or outer wall surface of the pipe body.
7. Inside diameter of the said plastic or rubber fuel pipe is from 6 to 12 mm.

### DESCRIPTION OF THE DRAWINGS

FIG. 1 is a three-dimensional view of a nano or sub-nano fuel pipes for vehicles and ships;

FIG. 2 is a side view of embodiments 1 and 2: a nano or sub-nano fuel pipe for vehicles and ships. The pipe comprises a carrier. The structures of the carrier are made up of nano or sub-nano granules, and the carrier is the whole body of pipe.

FIG. 3 is a side view of embodiments 3 and 4: a nano or sub-nano fuel pipe for vehicles and ships with an interior layer of paste carrier;

FIG. 4 is a side view of embodiments 5 and 6: a nano or sub-nano fuel pipe for vehicles and ships with an exterior layer of paste carrier;

FIG. 5 is a side view of embodiments 7 and 8: a nano or sub-nano fuel pipe for vehicles and ships with interior layer carrier; the structures of the carrier are made up of nano or sub-nano granules, and the carrier is the interior wall of the pipe body.

FIG. 6 is a side view of embodiments 9 and 10: a nano or sub-nano fuel pipe for vehicles and ships with exterior layer carrier; the structures of carrier of the pipe are made up of nano or sub-nano granules, and the carrier is the exterior wall of the pipe body.

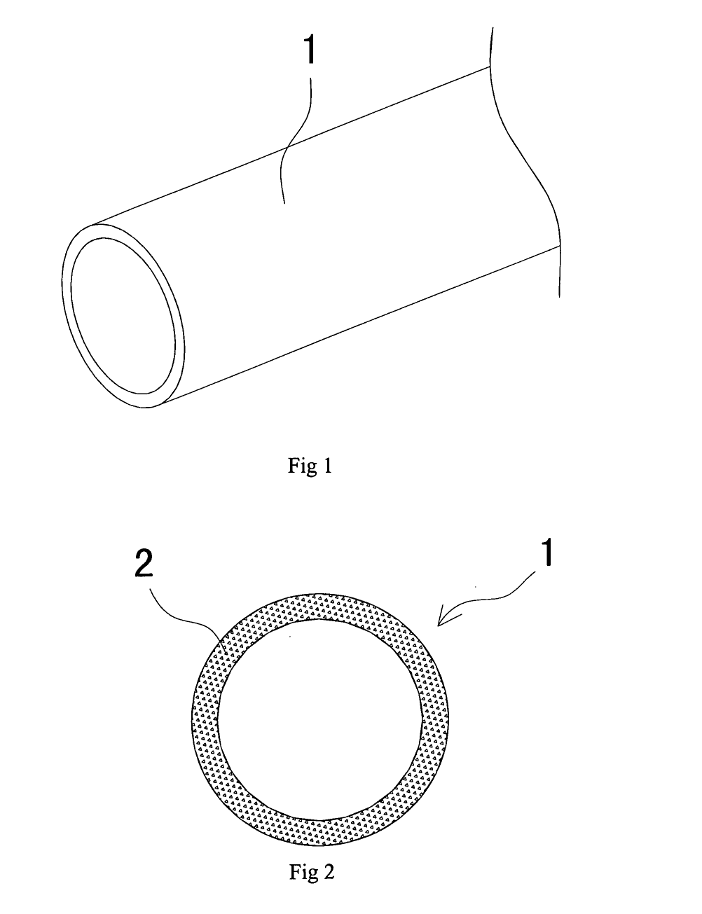

### DETAILED DESCRIPTION OF THE INVENTION

The terms and contents in the above technique are explained as follows:
1. In the above technique, the said “Nano or sub-nano fuel pipe for vehicles and ships” means nano or sub-nano fuel pipes in the internal combustion engines used in vehicles and ships that consume gasoline or diesel oil.
2. In the above technique, the said “nano or sub-nano tourmaline ore granules” can generate FIR and anion, and the said “nano or sub-nano germanium ore granules” mainly generates anions. Other materials that can generate anions include, but are not limited to: Gui gems, Shenzhou stones and tourmaline. These anion materials can be used either separately or with two or more combined.
3. In the above technique, when nano or sub-nano fuel pipes adopt the granule structures, nano or sub-nano granules with FIR and anions are mixed with general fuel pipe rubber or plastic materials. In the structures of carrier, 5-15% in weight is nano or sub-nano granule materials and left 85˜95% in weight is rubber or plastic.
4. In the above technique, when nano or sub-nano fuel pipes adopt paste structure, nano or sub-nano granules with FIR and anions are mixed with general fuel pipe rubber or plastic materials in a form of paste. In the structures of carrier, 5-15% in weight is nano or sub-nano materials and left 85˜95% in weight is rubber or plastic.
5. Tourmaline nano ore granules can generate high FIR and the emission rate up to 96%, which is higher than what regular tourmaline ore granules can generate. Nano germanium ore granules can generate more anions than regular germanium ore granules.
6. Tourmaline sub-nano ore granules can generate a FIR and the emission rate up to 92%, which is higher than what regular tourmaline ore granules can generate. Sub-nano germanium ore granules can generate more anions than regular germanium ore granules.
7. Inside diameter of nano or sub-nano FIR and anion fuel pipe is from 6 to 12 mm.
8. Size of nano granules is from 1 nm to 100 nm.
9. Size of sub-nano granules is from 101 nm to 999 nm.

The principle of the present invention is: when the fuel flows to FIR anion fuel pipe for vehicles and ships, the carrier structures of the said pipe emits FIR and anion. The emission directly acts upon the fuel. The van der Waals force between fuel molecules is destroyed by the effects of FIR and anion. Long-chain molecules become single molecules and/or short-chain molecules. Therefore the average distances between molecules increases and fuel molecules have more space free to move. As a result, burning efficiency of the fuel will be improved greatly and the exhausted toxic gases will drop correspondingly.

Because of the application of the said technique, this present invention of FIR and anion fuel pipe for vehicles and ships have the following advantages over existing non-FIR and anion technologies:
1. The present invention of nano or sub-nano FIR anion fuel pipe for vehicles and ships itself is a very good fuel economizer besides its fuel transportation. Nano or sub-nano FIR anion fuel pipe can save up to 12% fuels more than what non-nano FIR fuel economizers in the market can save;
2. The present invention of nano or sub-nano FIR anion fuel pipe for vehicles and ships emits FIR and anions. This emission rate is increased up to 96% from ˜85% by non-nano FIR and anion pipe. This emission rate provides an unexpected result.

The present invention has been illustrated with samples. Six embodiments of the present invention are: a nano or sub-nano FIR anion fuel rubber or plastic pipe for vehicles and ship comprises a pipe body 1; there is FIR and anion nano or sub-nano granule carrier 2 in said pipe body 1; this nano or sub-nano granule carrier 2 comprises tourmaline or tourmaline and germanium nano or sub-nano ore granules. Detailed embodiments are described as follows.
1. The carrier labeled as 2 is the whole body of the pipe with nano granules as shown in FIG. 2;
2. The carrier labeled as 2 is the whole body of the pipe with sub-nano granules as shown in FIG. 2;
3. The carrier labeled as 5 is the interior wall of the pipe with nano granules as shown in FIG. 5;
4. The carrier labeled as 5 is the interior wall of the pipe with sub-nano granules as shown in FIG. 5;
5. The carrier labeled as 6 is the exterior wall of the pipe with nano granules as shown in FIG. 6;
6. The carrier labeled as 6 is the exterior wall of the pipe with sub-nano granules as shown in FIG. 6.

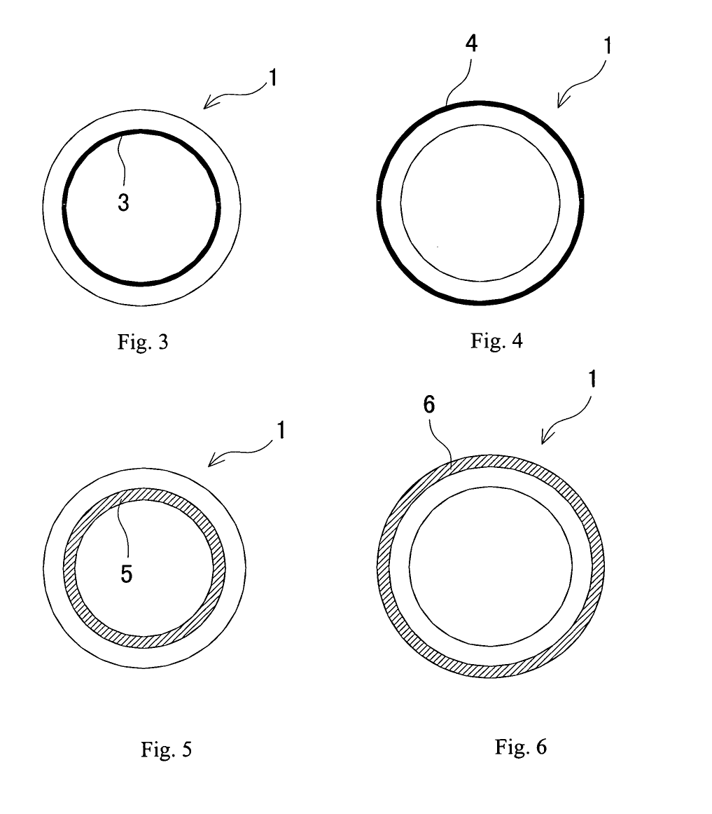

Another four embodiments of the present invention are: a FIR anion fuel plastic or rubber pipe for vehicles and ships comprise a pipe body 1. On the interior or exterior wall of the pipe body 1 there is a layer of FIR and anion paste carrier labeled as 3 or 4, which consists of tourmaline or tourmaline and germanium nano or sub-nano ore granules. A layer of paste carrier will be pasted on the interior or exterior walls of said pipes as shown in FIG. 3 and FIG. 4, respectively. Again, detailed embodiments are described as follows:
7. The paste carrier labeled as 3 is pasted in the inner wall surface of the pipe with nano granules as shown in FIG. 3;
8. The paste carrier labeled as 3 is pasted in the inner wall surface of the pipe with sub-nano granules as shown in FIG. 3;
9. The paste carrier labeled as 4 is pasted in the outer wall surface of the pipe with nano granules as shown in FIG. 4;
10. The paste carrier labeled as 4 is pasted in the outer wall surface of the pipe with sub-nano granules as shown in FIG. 4.

1. A rubber or plastic fuel pipe, wherein the said pipe comprise a nano or sub-nano far infrared ray (FIR) and anion carrier and structures of said carrier are made up of nano or sub-nano tourmaline granule materials or tourmaline and germanium ore granule material.

2. A rubber or plastic fuel pipe as in claim 1, wherein the structures of the said carrier are made up of nano FIR and anion granules and the said carrier is the whole body of the said pipe.

3. A rubber or plastic fuel pipe as in claim 1, wherein the structures of the said carrier are made up of sub-nano FIR and anion granules and the said carrier is the whole body of the said pipe.

4. A rubber or plastic fuel pipe as in claim 1, wherein the structures of the said carrier are made up of nano FIR and anion granules and the said carrier are the interior or exterior wall of the said pipe.

5. A rubber or plastic fuel pipe as in claim 1, wherein the structures of the said carrier are made up of sub-nano FIR and anion granules and the said carrier is the interior or exterior wall of the said pipe.

6. A rubber or plastic fuel pipe as in claim 1, wherein the said carrier is nano FIR and anion carrier pasted to the inner or outer wall surface of the said pipe.

7. A rubber or plastic fuel pipe as in claim 1, wherein the said carrier is sub-nano FIR and anion carrier pasted to the inner or outer wall surface of the said pipe.

8. A rubber or plastic fuel pipe as in claim 1, wherein inside diameter of said pipe is from 6 to 12 mm.
